(19) United States
(12) Patent Application Publication
(10) Pub. No.: US 2023/0206756 A1
(43) Pub. Date: Jun. 29, 2023

(54) METHOD AND SYSTEM OF CONTROLLING TRAFFIC LIGHTING APPARATUS, ELECTRONIC DEVICE AND STORAGE MEDIUM

(71) Applicant: Apollo Intelligent Connectivity (Beijing) Technology Co., Ltd., Beijing (CN)

(72) Inventors: Weiyang WANG, Beijing (CN); Shaogeng LIU, Beijing (CN); Wei MA, Beijing (CN); Chen WANG, Beijing (CN)

(21) Appl. No.: 18/111,997

(22) Filed: Feb. 21, 2023

(30) Foreign Application Priority Data
Feb. 25, 2022 (CN) 202210183470.0

(51) Int. Cl. G08G 1/07

(52) U.S. Cl. CPC G08G 1/07

(57) ABSTRACT

A method and a system of controlling a traffic lighting apparatus, an electronic device, and a storage medium, which relate to a field of computer technology, and in particular to a field of intelligent transportation technology. The method of controlling the traffic lighting apparatus includes: generating, in response to a state control operation for a virtual identification of the lighting apparatus being received, a control request based on the state control operation, where the control request is used to control a state of the lighting apparatus; sending the control request; and updating, in response to a state control result for the control request being received, display data of the virtual identification for the lighting apparatus based on the state control result.

### CROSS REFERENCE TO RELATED APPLICATION

This application claims priority to Chinese Patent Application No. 202210183470.0, filed on Feb. 25, 2022, the entire content of which is incorporated herein in its entirety by reference.

### TECHNICAL FIELD

The present disclosure relates to a field of computer technology, in particular to a field of intelligent transportation technology, and more particularly, to a method and a system of controlling a traffic lighting apparatus, an electronic device, and a storage medium.

### BACKGROUND

In a field of traffic, in order to ensure traffic safety, it is necessary to use a lighting apparatus for lighting under a low light condition. The lighting apparatus includes, for example, a street lamp. It is necessary to control the lighting apparatus to be turned on or off according to a brightness of light. A method of controlling the lighting apparatus in related art is not convenient, quick and intelligent enough.

### SUMMARY

The present disclosure provides a method and a system of controlling a traffic lighting apparatus, an electronic device, and a storage medium.

According to an aspect of the present disclosure, a method of controlling a traffic lighting apparatus is provided, including: generating, in response to a state control operation for a virtual identification of the lighting apparatus being received, a control request based on the state control operation, wherein the control request is configured to control a state of the lighting apparatus; sending the control request; and updating, in response to a state control result for the control request being received, display data of the virtual identification for the lighting apparatus based on the state control result.

According to another aspect of the present disclosure, a method of controlling a traffic lighting apparatus is provided, including: forwarding a control request in response to the control request being received, wherein the control request is generated based on a state control operation for a virtual identification of the lighting apparatus, and the control request is configured to control a state of the lighting apparatus; and forwarding a state control result in response to obtaining the state control result for the control request, wherein the state control result is configured to update display data of the virtual identification for the lighting apparatus.

According to another aspect of the present disclosure, an electronic device is provided, including: at least one processor; and a memory communicatively connected to the at least one processor, wherein the memory stores instructions executable by the at least one processor, and the instructions, when executed by the at least one processor, are configured to cause the at least one processor to implement the above-mentioned method of controlling the traffic lighting apparatus.

According to another aspect of the present disclosure, a non-transitory computer-readable storage medium having computer instructions therein is provided, wherein the computer instructions are used to cause a computer system to implement the above-mentioned method of controlling the traffic lighting apparatus.

According to another aspect of the present disclosure, a system of controlling a traffic lighting apparatus is provided, including a client, a server, and a control center. The client is configured to generate, in response to a state control operation for a virtual identification of the lighting apparatus being received, a control request based on the state control operation; send the control request, wherein the control request is configured to control a state of the lighting apparatus; and update, in response to a state control result for the control request being received, display data of the virtual identification for the lighting apparatus based on the state control result. The server is communicatively connected to the client and configured to forward a control request in response to the control request being received, wherein the control request is generated based on a state control operation for a virtual identification of the lighting apparatus, and the control request is configured to control a state of the lighting apparatus; and forward a state control result in response to obtaining the state control result for the control request, wherein the state control result is configured to update display data of the virtual identification for the lighting apparatus. The control center is communicatively connected to the server and configured to control a state of the lighting apparatus based on the control request from the server.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the present disclosure better and do not constitute a limitation to the present disclosure, in which:

FIG. 1 schematically shows a system architecture of controlling a traffic lighting apparatus according to an embodiment of the present disclosure;

FIG. 2 schematically shows a flowchart of a method of controlling a traffic lighting apparatus according to an embodiment of the present disclosure;

FIG. 3 schematically shows a flowchart of a method of controlling a traffic lighting apparatus according to another embodiment of the present disclosure;

FIG. 4 schematically shows a schematic diagram of an interaction between a client and a server according to an embodiment of the present disclosure;

FIG. 5 schematically shows a schematic diagram of a system of controlling a traffic lighting apparatus according to an embodiment of the present disclosure;

FIG. 6 schematically shows a block diagram of an apparatus of controlling a traffic lighting apparatus according to an embodiment of the present disclosure;

FIG. 7 schematically shows a block diagram of an apparatus of controlling a traffic lighting apparatus according to another embodiment of the present disclosure; and

FIG. 8 is a block diagram of an electronic device for implementing a method of controlling a traffic lighting apparatus according to an embodiment of the present disclosure.

### DETAILED DESCRIPTION OF EMBODIMENTS

Exemplary embodiments of the present disclosure will be described below with reference to accompanying drawings, which include various details of the embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The terminology used herein is for the purpose of describing particular embodiments only and is not intended to limit the present disclosure. The terms “comprise”, “include”, “contain” and the like as used herein indicate the presence of stated features, steps, operations and/or components, but do not preclude the presence or addition of one or more other features, steps, operations and/or components.

All terms (including technical and scientific terms) used herein have the meaning as commonly understood by those skilled in the art, unless otherwise defined. It should be noted that terms used herein should be construed to have meanings consistent with the context of the present specification and should not be construed in an idealized or overly rigid manner.

Where expressions like “at least one selected from A, B, or C, etc.,” are used, they should generally be interpreted in accordance with the meaning of the expression as commonly understood by those skilled in the art (for example, “a system having at least one selected from A, B, or C” shall include, but is not limited to, a system having A alone, a system having B alone, a system having C alone, a system having A and B, a system having A and C, a system having B and C, and/or a system having A , B, and C, etc.).

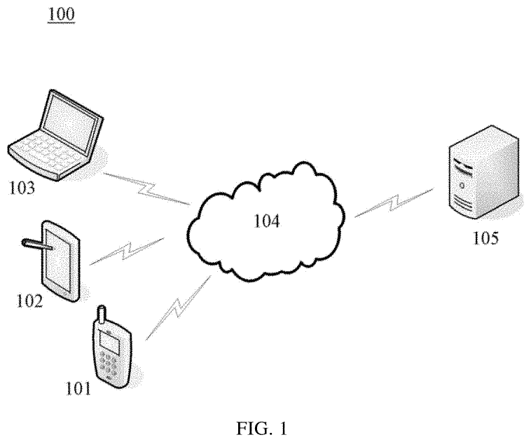

FIG. 1 schematically shows a system architecture of controlling a traffic lighting apparatus according to an embodiment of the present disclosure. It should be noted that FIG. 1 only shows an example of a system architecture to which embodiments of the present disclosure may be applied, so as to help those skilled in the art to understand the technical content of the present disclosure, but it does not mean that embodiments of the present disclosure cannot be used for other device, system, environment or scenario.

As shown in FIG. 1, a system architecture 100 according to this embodiment may include clients 101, 102, and 103, a network 104 and a server 105. The network 104 is a medium used to provide communication links between the clients 101, 102, and 103 and the server 105. The network 104 may include various connection types, such as a wired communication link, a wireless communication link, or a fiber optic cable, and the like.

The clients 101, 102, and 103 may be used by a user to interact with the server 105 through the network 104, so as to receive or send a message and the like. Various communication client applications may be installed on the clients 101, 102, and 103, such as a shopping application, a web browser application, a search application, an instant messaging tool, an email client, a social platform software, etc., (only examples).

The clients 101, 102, and 103 may be various electronic devices having a display screen and supporting web browsing, including but not limited to a smartphone, a tablet, a laptop, a desktop, and the like. The clients 101, 102, and 103 of the embodiments of the present disclosure may, for example, run an application program.

The server 105 may be a server that provides various services, such as a background management server (just an example) that provides support for a website browsed by the user using the clients 101, 102, and 103. The background management server may analyze and process a received user request and other data, and feedback a processing result (such as a web page, information, or data acquired or generated according to the user request) to the clients. In addition, the server 105 may also be a cloud server, that is, the server 105 has a cloud computing function.

In an example, a method of controlling a traffic lighting apparatus provided by an embodiment of the present disclose includes: generating, in response to a state control operation for a virtual identification of the lighting apparatus being received, a control request based on the state control operation, where the control request is used to control a state of the lighting apparatus; sending the control request; and updating, in response to a state control result for the control request being received, display data of the virtual identification for the lighting apparatus based on the state control result.

The method of controlling the traffic lighting apparatus provided by an embodiment of the present disclosure may be executed by the clients 101, 102, and 103. Accordingly, the apparatus of controlling the traffic lighting apparatus provided by an embodiment of the present disclosure may be provided in the clients 101, 102, and 103.

In another example, a method of controlling a traffic lighting apparatus provided by an embodiment of the present disclose includes: forwarding a control request in response to the control request being received, where the control request is generated based on a state control operation for a virtual identification of the lighting apparatus, and the control request is used to control a state of the lighting apparatus; and forwarding a state control result in response to obtaining the state control result for the control request, where the state control result is used to update display data of the virtual identification for the lighting apparatus.

The method of controlling the traffic lighting apparatus provided by an embodiment of the present disclosure may be executed by the server 105. Accordingly, the apparatus of controlling the traffic lighting apparatus provided by an embodiment of the present disclosure may be provided in the server 105.

It should be understood that the numbers of clients, network and server shown in FIG. 1 are merely illustrative. There may be any number of clients, networks, and servers as desired in practice.

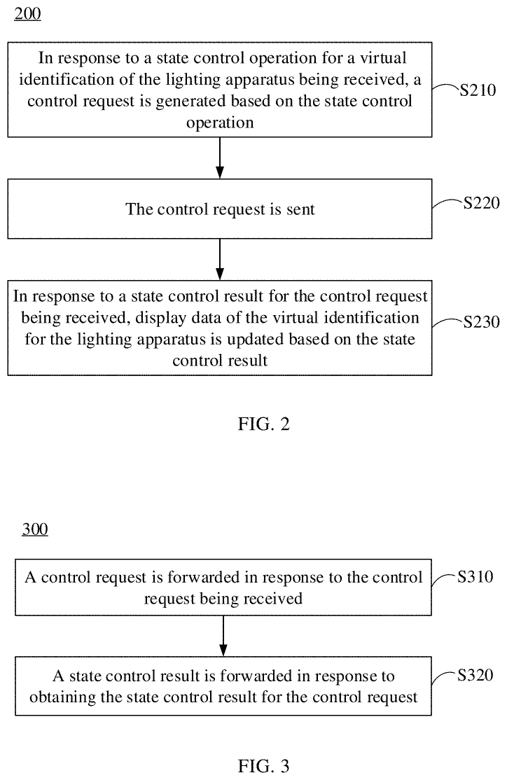

The following describes a method of controlling a traffic lighting apparatus according to an exemplary embodiment of the present disclosure with reference to FIGS. 2 to 5 in conjunction with the system architecture of FIG. 1.

FIG. 2 schematically shows a flowchart of a method of controlling a traffic lighting apparatus according to an embodiment of the present disclosure.

As shown in FIG. 2, a method 200 of controlling a traffic lighting apparatus according to an embodiment of the disclosure may include, for example, operations S210 to S230.

In operation S210, in response to a state control operation for a virtual identification of the lighting apparatus being received, a control request is generated based on the state control operation.

In operation S220, the control request is sent.

In operation S230, in response to a state control result for the control request being received, display data of the virtual identification for the lighting apparatus is updated based on the state control result.

The control method according to embodiments of the present disclosure may be executed by the client. The client pre-constructs a visualized virtual traffic scenario. The virtual traffic scenario includes a virtual identification for the lighting apparatus. Accordingly, a state of the lighting apparatus may be controlled by a user through the operating of the virtual identification. For example, one lighting apparatus corresponds to one virtual identification. The lighting apparatus includes, for example, a street lamp. Controlling the state of the lighting apparatus includes, for example, turning on the lighting apparatus or turning off the lighting apparatus. For example, turning on the lighting apparatus when light on a road is dark so as to ensure driving safety, and turning off the lighting apparatus when light on a road is bright so as to reduce resource consumption.

When a state control operation of the user for the virtual identification of the lighting apparatus is received by the client, the client generates a control request in response to the state control operation. The control request is used to control the state of the lighting apparatus. The virtual identification includes, for example, a legend, an icon, etc. The state control operation includes, for example, a turning on operation or a turning off operation. The client sends the control request to the server, so that the server performs a relevant operation based on the control request to obtain a state control result for the control request. The state control result includes, for example, a success of turning on the lighting apparatus, a success of turning off the lighting apparatus, a failure of turning on the lighting apparatus, a failure of turning off the lighting apparatus, etc.

After obtaining the state control result from the server, the client updates display data of the virtual identification for the lighting apparatus in the virtual traffic scenario based on the state control result. When the lighting apparatus is in a different state, the display data of the corresponding virtual identification is different. For example, when the lighting apparatus is turned on, a brightness indicated by the display data is large or a color indicated by the display data is white. When the lighting apparatus is turned off, the brightness indicated by the display data is small or the color indicated by the display data is black.

In general, if the state of the lighting apparatus needs to be controlled, it usually needs to be controlled through a system or software provided by a lighting apparatus manufacturer, which has certain limitations, and a control process is complex. According to an embodiment of the present disclosure, the state of the lighting apparatus may be directly controlled by the client, which improves the convenience and intelligence. In addition, the client pre-constructs the visualized virtual traffic scenario and operates the virtual identification for the lighting apparatus in the virtual traffic scenario to control the state of the lighting apparatus, which makes the control process more intuitive and visual.

In another example of the present disclosure, the server may monitor whether the state of the lighting apparatus changes or not in real time to obtain a state monitoring result, and send the state monitoring result to the client in real time. After receiving the state monitoring result, the client may update the display data of the virtual identification for the lighting apparatus in real time based on the state monitoring result, so as to improve a real-time performance of the display data of the virtual identification in the visualized virtual traffic scenario.

In another example of the present disclosure, the virtual traffic scenario is implemented by, for example, an application or a web page in the client. When logging into the application or the web page, it is usually necessary to initialize the virtual identification of the lighting apparatus in the virtual traffic scenario.

For example, the client generates an initialization request when logging into the application or the web page. When the initialization request is detected, the client may generate, for the lighting apparatus, a request for acquiring attribute data, and then send the request for acquiring attribute data to the server. The server may return attribute data for the lighting apparatus to the client based on the request for acquiring attribute data.

After receiving the attribute data for the lighting apparatus, the client may generate the virtual identification for the lighting apparatus based on the attribute data.

For example, the attribute data includes location data and initial state data. The location data represents, for example, a geographic location of the lighting apparatus on a road. For example, for a certain lighting apparatus, a coordinate location corresponding to the lighting apparatus may be determined in the pre-constructed virtual traffic scenario based on the location data of the lighting apparatus, and a virtual identification corresponding to the lighting apparatus may be set at the coordinate location.

Next, the display data for the virtual identification is initialized based on the initial state data. For example, the initial state data represents that the lighting apparatus is currently in a turning on state, a turning off state, or a fault state, etc. The display data of the virtual identification may be set based on the initial state data. For example, when initial state data of a certain lighting apparatus represents that the lighting apparatus is in the turning on state, the display data of the virtual identification corresponding to the lighting apparatus is initialized so that the initialized display data indicates that the brightness of the lighting apparatus is large or the color is white, which indicates that the lighting apparatus is in the turning on state.

According to an embodiment of the present disclosure, when initialization is required, the client requests to obtain the latest attribute data, and performs initialization based on the latest attribute data, which avoids a situation that information in the virtual traffic scenario is not updated in time resulting in inaccurate information after the location of the lighting apparatus or the state of the lighting apparatus changes in a real environment, thus improving the authenticity of the information in the virtual traffic scenario.

FIG. 3 schematically shows a flowchart of a method of controlling a traffic lighting apparatus according to another embodiment of the present disclosure.

As shown in FIG. 3, a method 300 of controlling a traffic lighting apparatus according to an embodiment of the disclosure may include, for example, operations S310 to S320.

In operation S310, a control request is forwarded in response to the control request being received.

In operation S320, a state control result is forwarded in response to obtaining the state control result for the control request.

For example, the control method according to embodiments of the present disclosure may be executed by, for example, the server. After receiving the control request from the client, the server forwards the control request to a control center of the lighting apparatus manufacturer for state control. The control request is generated based on the state control operation for the virtual identification of the lighting apparatus. The control request is used to control the state of the lighting apparatus.

After the control center of the lighting apparatus manufacturer updates the state of the lighting apparatus based on the control request, the server may obtain the state control result. The state control result includes, for example, the success of turning on the lighting apparatus, the success of turning off the lighting apparatus, the failure of turning on the lighting apparatus, the failure of turning off the lighting apparatus, etc.

In an example, the server may actively monitor whether the control center updates the state of the lighting apparatus based on the control request or not, thereby generating the state control result. In another example, after updating the state of the lighting apparatus based on the control request, the control center may generate the state control result and send the state control result to the server. After obtaining the state control result, the server forwards the state control result to the client, so that the client updates the display data of the virtual identification for the lighting apparatus based on the state control result.

According to an embodiment of the present disclosure, in order to solve the problem of limitation and complexity in controlling the state of the lighting apparatus through the system or software provided by the lighting apparatus manufacturer, the state of the lighting apparatus may be directly controlled by the client through an interaction between the server and the client, which improves the convenience and intelligence of the control process. In addition, the client pre-constructs the visualized virtual traffic scenario and operates the virtual identification for the lighting apparatus in the virtual traffic scenario to control the state of the lighting apparatus, which makes the control process more intuitive and visual.

In another example of the present disclosure, the server may monitor whether the state of the lighting apparatus changes in real time or not so as to obtain the state monitoring result. The state monitoring result is used to update the display data of the virtual identification for the lighting apparatus. Then the server sends the state monitoring result to the client in real time. After receiving the state monitoring result, the client may update the display data of the virtual identification in real time based on the state monitoring result, so as to improve a real-time performance of the display data of the virtual identification in the visualized virtual traffic scenario.

In an example, the server includes a database. The database is used to store the attribute data for the lighting apparatus. The server may maintain the database in real time according to the state monitoring result. For example, the server updates the attribute data in the database in real time based on the state monitoring result to ensure the validity of the data in the database, so that the latest attribute data may be provided when the client requests the attribute data in the database.

In another example of the present disclosure, the virtual traffic scenario of the client is implemented by the application or the web page. When logging into the application or the web page, the client needs to initialize the virtual identification of the lighting apparatus in the virtual traffic scenario. Therefore, the client needs to send the request for acquiring attribute data for the lighting apparatus to the server.

When receiving the request for acquiring attribute data from the client, the server acquires the attribute data for the lighting apparatus from the database and sends the attribute data to the client, so that the client generates the virtual identification for the lighting apparatus based on the attribute data.

For example, the attribute data includes the location data and the initial state data. The client adds the virtual identification for the lighting apparatus in the pre-constructed virtual traffic scenario based on the location data. The client initializes the display data of the virtual identification based on the initial state data.

For example, the location data represents the geographic location of the lighting apparatus on the road. For a certain lighting apparatus, the client may determine a coordinate location corresponding to the lighting apparatus in the pre-constructed virtual traffic scenario based on the location data of the lighting apparatus, and set a virtual identification corresponding to the lighting apparatus at the coordinate location.

Next, the client initializes the display data of the virtual identification based on the initial state data. For example, the initial state data represents that the lighting apparatus is currently in the turning on state, the turning off state, or the fault state, etc. The display data of the virtual identification may be set based on the initial state data. For example, when initial state data of a certain lighting apparatus represents that the lighting apparatus is in the turning on state, the display data of the virtual identification corresponding to the lighting apparatus is initialized so that the initialized display data indicates that the brightness of the lighting apparatus is large or the color is white, which indicates that the lighting apparatus is in the turning on state.

According to an embodiment of the present disclosure, the server sends the latest attribute data to the client based on the request of the client, so that the client performs initialization based on the latest attribute data, which avoids the situation that the information in the virtual traffic scenario is not updated in time resulting in the inaccurate information after the location of the lighting apparatus or the state of the lighting apparatus changes in the real environment, thus improving the authenticity of the information in the virtual traffic scenario.

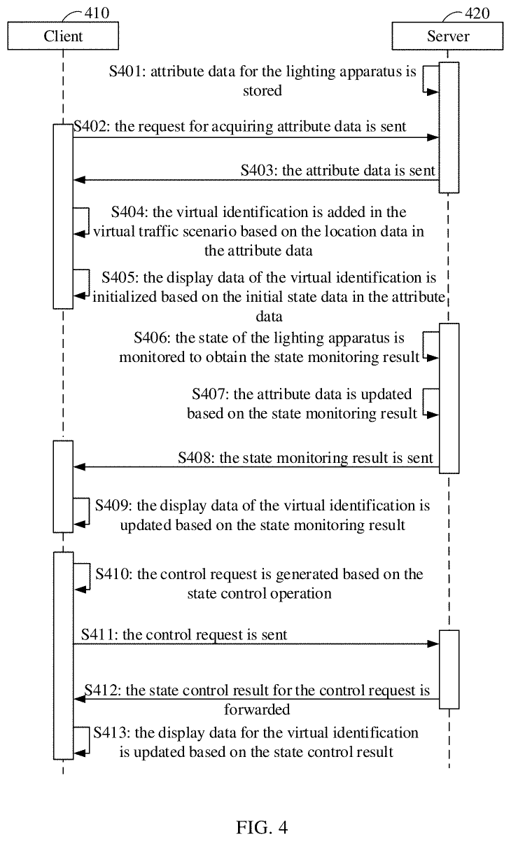

FIG. 4 schematically shows a schematic diagram of an interaction between a client and a server according to an embodiment of the present disclosure.

As shown in FIG. 4, the method of controlling a traffic lighting apparatus according to an embodiment of the present disclosure may be executed by, for example, a client 410 and a server 420, specifically including operations S401 to S413.

In operation S401, a server 420 pre-stores attribute data for the lighting apparatus in a database. The attribute data includes the location data and the initial state data.

In operation S402, the client 410 sends the request for acquiring attribute data to the server 420. The request for acquiring attribute data is used to request the attribute data for initialization.

In operation S403, the server 420 sends the attribute data to the client 410. For example, after receiving the request for acquiring attribute data, the server 420 sends the attribute data to the client 410 in response to the request for acquiring attribute data.

In operation S404, the client 410 adds the virtual identification for the lighting apparatus in the virtual traffic scenario based on the location data in the attribute data.

In operation S405, the client 410 initializes the display data of the virtual identification in the virtual traffic scenario based on the initial state data in the attribute data.

In operation S406, the server 420 monitors the state of the lighting apparatus in real time, so as to obtain the state monitoring result.

In operation S407, the server 420 updates the attribute data in the database based on the state monitoring result.

In operation S408, the server 420 sends the state monitoring result to the client 410 in real time.

Operations S406 to S408 may be performed before or after any other operations.

In operation S409, the client 410 updates the display data of the virtual identification in the virtual traffic scenario in real time based on the state monitoring result.

In operation S410, after receiving the state control operation from the user, the client 410 generates the control request based on the state control operation.

In operation S411, the client 410 sends the control request to the server 420.

In operation S412, the server 420 forwards the state control result for the control request to the client 410.

In operation S413, the client 410 updates the display data of the virtual identification in the virtual traffic scenario based on the state control result.

According to an embodiment of the present disclosure, in order to solve the problem of limitation and complexity in controlling the state of the lighting apparatus through the system or software provided by the lighting apparatus manufacturer, the state of the lighting apparatus may be directly controlled by the client through the interaction between the server and the client, which improves the convenience and intelligence of the state control.

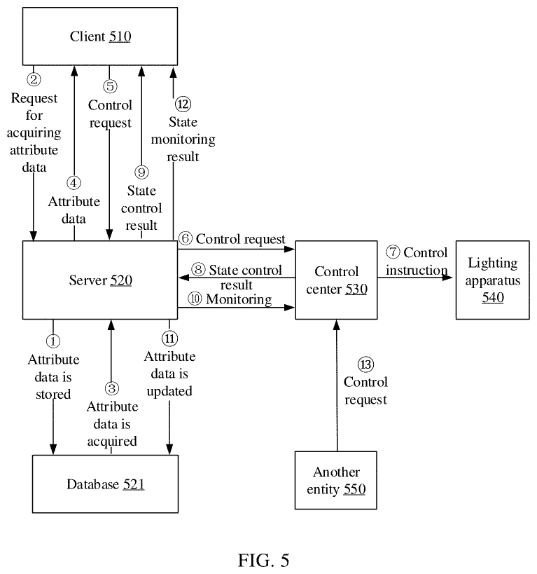

FIG. 5 schematically shows a schematic diagram of a system of controlling a traffic lighting apparatus according to an embodiment of the present disclosure.

As shown in FIG. 5, a system of controlling a traffic lighting apparatus according to an embodiment of the present disclosure includes, for example, a client 510, a server 520, and a control center 530.

For example, the client 510 is communicatively connected to the server 520. The control center 530 is communicatively connected to the server 520. The control center 530 is, for example, a system belonging to the lighting apparatus manufacturer. The control center 530 is used to control the state of a lighting apparatus 540 based on the control request from the server 520.

For example, the server 520 includes a database 521. The server 520 may store the attribute data for the lighting apparatus in the database 521. When the client 510 needs to perform initialization, the client 510 sends the request for acquiring attribute data to the server 520. After receiving the request for acquiring attribute data, the server 520 acquires the attribute data from the database 521 and sends the attribute data to the client 510 for initialization.

After receiving the state control operation of the user for the virtual identification of the lighting apparatus 540, the client 510 generates the control request based on the state control operation and sends the control request to the server 520.

After receiving the control request, the server 520 forwards the control request to the control center 530. The control center 530 generates a control instruction based on the control request, and sends the control instruction to the lighting apparatus 540 to control the state of the lighting apparatus 540.

In an example, the server 520 may actively monitor whether the control center 530 controls the state of the lighting apparatus 540 based on the control request or not. If it is monitored that the control center 530 controls the state of the lighting apparatus 540 based on the control request, the server 520 generates the state control result for the control request. In another example, after controlling the state of the lighting apparatus 540 based on the control request, the control center 530 may generate the state control result and send the state control result to the server 520.

After obtaining the state control result for the control request, the server 520 forwards the state control result to the client 510. The client 510 updates the display data of the virtual identification based on the state control result.

In another example, the server 520 may also monitor a state control situation of the lighting apparatus 540 by the control center 530 in real time to obtain the state monitoring result, and update the attribute data in the database 521 based on the state monitoring result. In addition, the server 520 may also send the state monitoring result to the client 510, so that the client 510 updates the display data of the virtual identification based on the state monitoring result.

In another example, the control center 530 may also communicate with another entity 550. The another entity 550 may send the control request to the control center 530 to request the control center 530 to control the state of the lighting apparatus 540 based on the control request. After receiving the control request from the another entity 550, the control center 530 generates the control instruction based on the control request, and sends the control instruction to the lighting apparatus 540 to control the state of the lighting apparatus 540. After it is monitored that the control center 530 controls the state of the lighting apparatus 540, the server 520 obtains the state monitoring result, updates the attribute data in the database 521 based on the state monitoring result, and sends the state monitoring result to the client 510.

According to an embodiment of the present disclosure, in order to solve the problem of limitation and complexity in controlling the state of the lighting apparatus through the system or software provided by the lighting apparatus manufacturer, the control of the state of the lighting apparatus is achieved by the interaction between the server and the client. The client pre-constructs the visualized virtual traffic scenario and operates the virtual identification for the lighting apparatus in the virtual traffic scenario to control the state of the lighting apparatus, which may quickly and batch control the state of the lighting apparatus within a large range (the whole road), and may intuitively watch the turning on state, the turning off state and the fault state of the lighting apparatus, thereby improving the intelligence of controlling the lighting apparatus.

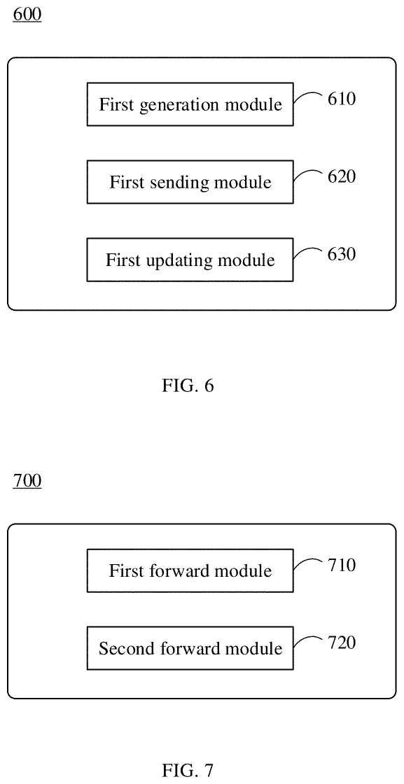

FIG. 6 schematically shows a block diagram of an apparatus of controlling a traffic lighting apparatus according to an embodiment of the present disclosure.

As shown in FIG. 6, an apparatus 600 of controlling a traffic lighting apparatus includes, for example, a first generation module 610, a first sending module 620 and a first updating module 630.

The first generation module 610 may be used to generate, in response to a state control operation for a virtual identification of the lighting apparatus being received, a control request based on the state control operation, where the control request is used to control a state of the lighting apparatus. According to an embodiment of the present disclosure, the first generation module 610 may perform, for example, the operation S210 described above with reference to FIG. 2, which will not be repeated here.

The first sending module 620 may be used to send the control request. According to an embodiment of the present disclosure, the first sending module 620 may perform, for example, the operation S220 described above with reference to FIG. 2, which will not be repeated here.

The first updating module 630 may be used to update, in response to a state control result for the control request being received, display data of the virtual identification for the lighting apparatus based on the state control result. According to an embodiment of the present disclosure, the first updating module 630 may perform, for example, the operation S230 described above with reference to FIG. 2, which will not be repeated here.

According to an embodiment of the present disclosure, the apparatus 600 may further include a second updating module used to update, in response to a state monitoring result for the lighting apparatus being received, the display data of the virtual identification for the lighting apparatus based on the state monitoring result.

According to an embodiment of the present disclosure, the apparatus 600 may further include a second generation module, a second sending module and a third generation module. The second generation module is used to generate, for the lighting apparatus, a request for acquiring attribute data, in response to an initialization request being detected. The second sending module is used to send the request for acquiring attribute data. The third generation module is used to generate, in response to attribute data for the lighting apparatus being received, the virtual identification for the lighting apparatus based on the attribute data.

According to an embodiment of the present disclosure, the attribute data includes the location data and the initial state data. The third generation module includes an addition sub-module and an initialization sub-module. The addition sub-module is used to add the virtual identification for the lighting apparatus in a pre-constructed virtual traffic scenario based on the location data. The initialization module is used to initialize the display data for the virtual identification based on the initial state data.

FIG. 7 schematically shows a block diagram of an apparatus of controlling a traffic lighting apparatus according to another embodiment of the present disclosure.

As shown in FIG. 7, an apparatus 700 of controlling a traffic lighting apparatus includes, for example, a first forward module 710 and a second forward module 720.

The first forward module 710 may be used to forward a control request in response to the control request being received, where the control request is generated based on a state control operation for a virtual identification of the lighting apparatus, and the control request is used to control a state of the lighting apparatus. According to an embodiment of the present disclosure, the first forward module 710 may perform, for example, the operation S310 described above with reference to FIG. 3, which will not be repeated here.

The second forward module 720 may be used to forward a state control result in response to obtaining the state control result for the control request, where the state control result is used to update display data of the virtual identification for the lighting apparatus. According to an embodiment of the present disclosure, the second forward module 720 may perform, for example, the operation S320 described above with reference to FIG. 3, which will not be repeated here.

According to an embodiment of the present disclosure, the apparatus 700 may further include a monitoring module and a first sending module. The monitoring module is used to monitor the state of the lighting apparatus to obtain a state monitoring result. The first sending module is used to send the state monitoring result, where the state monitoring result is used to update the display data of the virtual identification for the lighting apparatus.

According to an embodiment of the present disclosure, the apparatus 700 may further include an acquisition module and a second sending module. The acquisition module is used to acquire attribute data for the lighting apparatus in response to a request for acquiring attribute data for the lighting apparatus being received. The second sending module is used to send the attribute data. The attribute data is used for a generation of the virtual identification for the lighting apparatus, and the attribute data includes location data and initial state data, and the location data is used for an addition of the virtual identification for the lighting apparatus in a pre-constructed virtual traffic scenario, and the initial state data is used for an initialization of the display data for the virtual identification.

According to an embodiment of the present disclosure, the apparatus 700 may further include an updating module used to update the attribute data for the lighting apparatus based on the state monitoring result.

In the technical solution of the present disclosure, the collection, storage, use, processing, sending, provision, disclosure and application of the information in the virtual traffic scenario involved are all in compliance with the relevant laws and regulations, and necessary confidentiality measures have been taken, and do not violate the public order and good customs.

In the technical solution of the present disclosure, the authorization or consent of the user is acquired before the user's personal information is acquired or collected.

According to an embodiment of the present disclosure, the present disclosure further provides an electronic device, a readable storage medium, and a computer program product.

According to an embodiment of the present disclosure, the electronic device includes at least one processor; and a memory communicatively connected to the at least one processor, where the memory stores instructions executable by the at least one processor, and the instructions, when executed by the at least one processor, cause the at least one processor to implement the method of controlling the traffic lighting apparatus executed by the client or the method of controlling the traffic lighting apparatus executed by the server. The electronic device may include, for example, the above-mentioned client or server.

According to an embodiment of the present disclosure, a non-transitory computer-readable storage medium having computer instructions therein is provided, where the computer instructions are used to cause a computer system to implement the above-mentioned method of controlling the traffic lighting apparatus.

According to an embodiment of the present disclosure, a computer program product containing a computer program/instruction is provided, where the computer program/instruction, when executed by a processor, causes the processor to implement the above-mentioned method of controlling the traffic lighting apparatus executed by the client or the method of controlling the traffic lighting apparatus executed by the server.

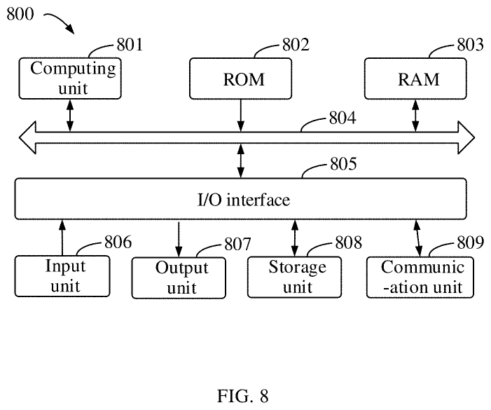

FIG. 8 is a block diagram of an electronic device for implementing a method of controlling a traffic lighting apparatus according to an embodiment of the present disclosure.

FIG. 8 shows a schematic block diagram of an exemplary electronic device 800 for implementing the embodiments of the present disclosure. The electronic device 800 is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the device 800 may include a computing unit 801, which may perform various appropriate actions and processing based on a computer program stored in a read-only memory (ROM) 802 or a computer program loaded from a storage unit 808 into a random access memory (RAM) 803. Various programs and data required for the operation of the device 800 may be stored in the RAM 803. The computing unit 801, the ROM 802 and the RAM 803 are connected to each other through a bus 804. An input/output (I/O) interface 805 is further connected to the bus 804.

Various components in the device 800, including an input unit 806 such as a keyboard, a mouse, etc., an output unit 807 such as various types of displays, speakers, etc., a storage unit 808 such as a magnetic disk, an optical disk, etc., and a communication unit 809 such as a network card, a modem, a wireless communication transceiver, etc., are connected to the I/O interface 805. The communication unit 809 allows the device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 801 may perform the various methods and processes described above, such as the method of controlling the traffic lighting apparatus. For example, in some embodiments, the method of controlling the traffic lighting apparatus may be implemented as a computer software program that is tangibly contained on a machine-readable medium, such as a storage unit 808. In some embodiments, part or all of a computer program may be loaded and/or installed on the device 800 via the ROM 802 and/or the communication unit 809. When the computer program is loaded into the RAM 803 and executed by the computing unit 801, one or more steps of the method of controlling the traffic lighting apparatus described above may be performed. Alternatively, in other embodiments, the computing unit 801 may be used to perform the method of controlling the traffic lighting apparatus in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may send the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of controlling a traffic lighting apparatus, comprising:
generating, in response to a state control operation for a virtual identification of the lighting apparatus being received, a control request based on the state control operation, wherein the control request is configured to control a state of the lighting apparatus;
sending the control request; and
updating, in response to a state control result for the control request being received, display data of the virtual identification for the lighting apparatus based on the state control result.

2. The method according to claim 1, further comprising:
updating, in response to a state monitoring result for the lighting apparatus being received, the display data of the virtual identification for the lighting apparatus based on the state monitoring result.

3. The method according to claim 1, further comprising:
generating, for the lighting apparatus, a request for acquiring attribute data, in response to an initialization request being detected;
sending the request for acquiring attribute data; and
generating, in response to attribute data for the lighting apparatus being received, the virtual identification for the lighting apparatus based on the attribute data.

4. The method according to claim 3, wherein the attribute data comprises location data and initial state data, and
the generating the virtual identification for the lighting apparatus based on the attribute data comprises:
adding the virtual identification for the lighting apparatus in a pre-constructed virtual traffic scenario based on the location data; and
initializing the display data for the virtual identification based on the initial state data.

5. The method according to claim 2, further comprising:
generating, for the lighting apparatus, a request for acquiring attribute data, in response to an initialization request being detected;
sending the request for acquiring attribute data; and
generating, in response to attribute data for the lighting apparatus being received, the virtual identification for the lighting apparatus based on the attribute data.

6. A method of controlling a traffic lighting apparatus, comprising:
forwarding a control request in response to the control request being received, wherein the control request is generated based on a state control operation for a virtual identification of the lighting apparatus, and the control request is configured to control a state of the lighting apparatus; and
forwarding a state control result in response to obtaining the state control result for the control request, wherein the state control result is configured to update display data of the virtual identification for the lighting apparatus.

7. The method according to claim 6, further comprising:
monitoring the state of the lighting apparatus to obtain a state monitoring result; and
sending the state monitoring result, wherein the state monitoring result is configured to update the display data of the virtual identification for the lighting apparatus.

8. The method according to claim 7, further comprising:
acquiring attribute data for the lighting apparatus in response to a request for acquiring attribute data for the lighting apparatus being received; and
sending the attribute data,
wherein the attribute data is configured for a generation of the virtual identification for the lighting apparatus, and the attribute data comprises location data and initial state data, and
wherein the location data is configured for an addition of the virtual identification for the lighting apparatus in a pre-constructed virtual traffic scenario, and the initial state data is configured for an initialization of the display data for the virtual identification.

9. The method according to claim 8, further comprising:
updating the attribute data for the lighting apparatus based on the state monitoring result.

10. An electronic device, comprising:
at least one processor; and
a memory communicatively connected to the at least one processor, wherein the memory stores instructions executable by the at least one processor, and the instructions, when executed by the at least one processor, are configured to cause the at least one processor to implement the method of claim 1.

11. The electronic device according to claim 10, wherein the instructions are further configured to cause the at least one processor to at least:
update, in response to a state monitoring result for the lighting apparatus being received, the display data of the virtual identification for the lighting apparatus based on the state monitoring result.

12. The electronic device according to claim 10, wherein the instructions are further configured to cause the at least one processor to at least:
generate, for the lighting apparatus, a request for acquiring attribute data, in response to an initialization request being detected;
send the request for acquiring attribute data; and
generate, in response to attribute data for the lighting apparatus being received, the virtual identification for the lighting apparatus based on the attribute data.

13. The electronic device according to claim 12, wherein the attribute data comprises location data and initial state data, and
wherein the instructions are further configured to cause the at least one processor to at least:
add the virtual identification for the lighting apparatus in a pre-constructed virtual traffic scenario based on the location data; and
initialize the display data for the virtual identification based on the initial state data.

14. An electronic device, comprising:
at least one processor; and
a memory communicatively connected to the at least one processor, wherein the memory stores instructions executable by the at least one processor, and the instructions, when executed by the at least one processor, are configured to cause the at least one processor to implement the method of claim 6.

15. The electronic device according to claim 14, wherein the instructions are further configured to cause the at least one processor to at least:
monitor the state of the lighting apparatus to obtain a state monitoring result; and
send the state monitoring result, wherein the state monitoring result is configured to update the display data of the virtual identification for the lighting apparatus.

16. The electronic device according to claim 15, wherein the instructions are further configured to cause the at least one processor to at least:
acquire attribute data for the lighting apparatus in response to a request for acquiring attribute data for the lighting apparatus being received; and
send the attribute data,
wherein the attribute data is configured for a generation of the virtual identification for the lighting apparatus, and the attribute data comprises location data and initial state data, and
wherein the location data is configured for an addition of the virtual identification for the lighting apparatus in a pre-constructed virtual traffic scenario, and the initial state data is configured for an initialization of the display data for the virtual identification.

17. The electronic device according to claim 16, wherein the instructions are further configured to cause the at least one processor to at least:
update the attribute data for the lighting apparatus based on the state monitoring result.

18. A non-transitory computer-readable storage medium having computer instructions therein, wherein the computer instructions are configured to cause a computer system to implement the method of claim 1.

19. A non-transitory computer-readable storage medium having computer instructions therein, wherein the computer instructions are configured to cause a computer system to implement the method of claim 6.

20. A system of controlling a traffic lighting apparatus, comprising:
a client configured to at least:
generate, in response to a state control operation for a virtual identification of the lighting apparatus being received, a control request based on the state control operation, wherein the control request is configured to control a state of the lighting apparatus;
send the control request; and
update, in response to a state control result for the control request being received, display data of the virtual identification for the lighting apparatus based on the state control result;
a server communicatively connected to the client and configured to at least:
forward a control request in response to the control request being received, wherein the control request is generated based on a state control operation for a virtual identification of the lighting apparatus, and the control request is configured to control a state of the lighting apparatus; and
forward a state control result in response to obtaining the state control result for the control request, wherein the state control result is configured to update display data of the virtual identification for the lighting apparatus; and
a control center communicatively connected to the server and configured to control a state of the lighting apparatus based on a control request from the server.
